(19) United States
(12) Patent Application Publication
(10) Pub. No.: US 2026/0343546 A1
(43) Pub. Date: Oct. 29, 2026

(54) METHOD AND APPARATUS OF UPLINK TRANSMISSION

(71) Applicant: LENOVO (BEIJING) LIMITED, Beijing (CN)

(72) Inventors: Wei Ling, Beijing (CN); Yi Zhang, Beijing (CN); Bingchao Liu, Beijing (CN); Chenxi Zhu, Beijing (CN); Lingling Xiao, Beijing (CN)

(21) Appl. No.: 19/103,841

(22) PCT Filed: Aug. 17, 2022
(86) PCT No.: PCT/CN2022/112979

§ 371 Date: Feb. 14, 2025

(51) Int. Cl. H04W 72/21; H04L 5/00

(52) U.S. Cl. CPC H04W 72/21; H04L 5/0055

(57) ABSTRACT

Embodiments of the present application are related to a method and apparatus of uplink transmission. An exemplary method includes: receiving information indicating one or more PUCCH resources which are expected to be transmitted on a slot; and determining a number of PUCCH resources to be transmitted on the slot from at least one PUCCH resource determined according to the one or more PUCCH resources and an UCI multiplexing mode, wherein the number of PUCCH resources is equal to or smaller than a configured or predefined maximum number and there is no overlapping PUCCH resources associated with a same beam in the number of PUCCH resources.

### TECHNICAL FIELD

Embodiments of the present application generally relate to wireless communication technology, especially to a method and an apparatus of uplink (UL) transmission, e.g., physical uplink control channel (PUCCH) transmission.

### BACKGROUND

Wireless communication systems are widely deployed to provide various telecommunication services, such as telephony, video, data, messaging, broadcasts, and so on. Wireless communication systems may employ multiple access technologies capable of supporting communication with multiple users by sharing available system resources (e.g., time, frequency, and power). Examples of wireless communication systems may include fourth generation (4G) systems, such as long term evolution (LTE) systems, LTE-advanced (LTE-A) systems, or LTE-A Pro systems, and fifth generation (5G) systems which may also be referred to as new radio (NR) systems.

Multi-transmit-receive point (TRP)/panel transmission has been introduced into NR since release 16 (Rel-16). However, when user equipment (UE) supports multi-panel simultaneous uplink transmission, there are still a mass of issues on uplink transmission to be solved. For example, according to a work item description (WID) approved on multiple-input multiple-output (MIMO) in NR Rel-18 includes the following items to facilitate simultaneous multi-panel UL transmission for higher uplink throughput and better reliability, focusing on frequency range (FR) 2 and multi-TRP (M-TRP), assuming up to 2 TRPs and up to 2 panels, and targeting customer premises equipment (CPE)/fixed wireless access (FWA)/vehicle/industrial devices (if applicable) as the following:
UL precoding indication for PUSCH, where no new codebook is introduced for multi-panel simultaneous transmission
   The total number of layers is up to four across all panels and total number of codewords is up to two across all panels, considering single downlink control information (DCI) and multi-DCI based multi-TRP operation.
UL beam indication for physical uplink control channel (PUCCH)/PUSCH, where unified transmission configuration information (TCI) framework extension in objective 2 is assumed, considering single DCI and multi-DCI based multi-TRP operation
   For the case of multi-DCI based multi-TRP operation, only PUSCH+PUSCH, or PUCCH+PUCCH is transmitted across two panels in a same carrier component (CC).

In addition, common beam framework specified in Rel-17 will be extended for multiple panel simultaneous UL transmission in Rel-18. That is, up to 2 common beams will be indicated for multi-panel simultaneous UL transmission, and a PUCCH resource can be transmitted with one or two common beams. According to legacy specification, at most two non-overlapping PUCCH resources may be transmitted on a slot according to some multiplexing rules or dropping rules, which may be related to uplink control information (UCI) priority of a PUCCH resource. However, two overlapping PUCCH resources with different beams can be selected if UE supports simultaneous UL transmission with multiple panels.

Therefore, uplink transmission, e.g., UCI multiplexing on PUCCH resource(s) can be enhanced considering multiple panel simultaneous UL transmission to increase efficiency of UCI transmission over PUCCH.

### SUMMARY OF THE APPLICATION

One objective of the embodiments of the present application is to provide a technical solution of uplink transmission, especially, a method and an apparatus of uplink transmission, e.g., PUCCH transmission in the scenario of multiple panel simultaneous UL transmission.

Some embodiments of the present application provide an apparatus of uplink transmission, e.g., UE, which may include: a transceiver; and a processor coupled to the transceiver, wherein the processor is configured to: receive information indicating one or more PUCCH resources which are expected to be transmitted on a slot; and determine a number of PUCCH resources to be transmitted on the slot from at least one PUCCH resource determined according to the one or more PUCCH resources and an UCI multiplexing mode, wherein the number of PUCCH resources is equal to or smaller than a configured or predefined maximum number and there is no overlapping PUCCH resources associated with a same beam in the number of PUCCH resources.

Some other embodiments of the present application provide a method of uplink transmission, which may include: receiving information indicating one or more PUCCH resources which are expected to be transmitted on a slot; and determining a number of PUCCH resources to be transmitted on the slot from at least one PUCCH resource determined according to the one or more PUCCH resources and an UCImultiplexing mode, wherein the number of PUCCH resources is equal to or smaller than a configured or predefined maximum number and there is no overlapping PUCCH resources associated with a same beam in the number of PUCCH resources.

In some embodiments of the present application, in the case that the UCI multiplexing mode is separate UCI multiplexing, one resourceSetToAddModList is configured for PUCCH resource configuration, and one PUCCH resource associated with a beam of the one or more PUCCH resources carrying hybrid automatic repeat request-acknowledge (HARQ-ACK) information with corresponding downlink control information (DCI) is overlapping with at least one other PUCCH resource carrying other UCI information associated with the beam of the one or more PUCCH resources, the at least one PUCCH resource includes a PUCCH resource for multiplexing the HARQ-ACK information and the other UCI information. Wherein, the PUCCH resource is determined from a PUCCH resource set determined from the resourceSetToAddModList according to a total bit number of the HARQ-ACK information and the other UCI information, and in the case that the PUCCH resource set is a first PUCCH resource set determined from the resourceSetToAddModList and a total number of PUCCH resources associated with the beam in the first PUCCH resource set is larger than 8, the PUCCH resource for multiplexing the HARQ-ACK information and the other UCI information is determined from all PUCCH resources associated with the beam in the first PUCCH resource set according to a PUCCH resource indicator (PRI) field in a last DCI corresponding to the HARQ-ACK information with corresponding DCI and a control resource set (CORESET) of the last DCI corresponding to the HARQ-ACK information with corresponding DCI; otherwise, the PUCCH resource for multiplexing the HARQ-ACK information and the other UCI information is determined from all PUCCH resources associated with the beam in the PUCCH resource set according to a PRI field in a last DCI corresponding to the HARQ-ACK information with corresponding DCI.

In some embodiments of the present application, in the case that the UCI multiplexing mode is separate UCI multiplexing, one resourceSetToAddModList is configured for PUCCH resource configuration, and a PUCCH resource of the at least one PUCCH resource carries HARQ-ACK information with corresponding DCI associated with a beam, the PUCCH resource is determined from a PUCCH resource set determined from the resourceSetToAddModList according to a total bit number of the HARQ-ACK information, wherein, in the case that the PUCCH resource set is a first PUCCH resource set determined from the resourceSetToAddModList and a total number of PUCCH resources associated with the beam in the first PUCCH resource set is larger than 8, the PUCCH resource is determined from all PUCCH resources associated with the beam in the first PUCCH resource set according to a PRI field in a last DCI corresponding to the HARQ-ACK information with corresponding DCI and a CORESET of the last DCI corresponding to the HARQ-ACK information with corresponding DCI; otherwise, the PUCCH resource is determined from all PUCCH resources associated with the beam in the PUCCH resource set according to a PRI field in a last DCI corresponding to the HARQ-ACK information with corresponding DCI.

In some embodiments of the present application, in the case that the UCI multiplexing mode is separate UCI multiplexing, two resourceSetToAddModLists are configured for PUCCH resource configuration, and one PUCCH resource associated with a beam of the one or more PUCCH resources carrying HARQ-ACK information with corresponding DCI is overlapping with at least one other PUCCH resource associated with the beam of the one or more PUCCH resources carrying other UCI information, the at least one PUCCH resource includes a PUCCH resource for multiplexing the HARQ-ACK information and the other UCI information, wherein, the PUCCH resource is determined from a PUCCH resource set associated with the beam determined from a resourceSetToAddModList associated with the beam of the two resourceSetToAddModLists according to a total bit number of the HARQ-ACK information and the other UCI information, and in the case that the PUCCH resource set is a first PUCCH resource set determined from the resourceSetToAddModList associated with the beam and a total number of PUCCH resources in the first PUCCH resource set is larger than 8, the PUCCH resource is determined from all PUCCH resources in the first PUCCH resource set according to a PRI field in a last DCI corresponding to the HARQ-ACK information with corresponding DCI and a CORESET of the last DCI corresponding to the HARQ-ACK information with corresponding DCI; otherwise, the PUCCH resource is determined from all PUCCH resources in the PUCCH resource set associated with the beam according to a PRI field in a last DCI corresponding to the HARQ-ACK information with corresponding DCI.

In some embodiments of the present application, in the case that the UCI multiplexing mode is separate UCI multiplexing, two resourceSetToAddModLists are configured for PUCCH resource configuration, and a PUCCH resource of the at least one PUCCH resource carries HARQ-ACK information with corresponding DCI associated with a beam, the PUCCH resource is determined from a PUCCH resource set associated with the beam determined from a resourceSetToAddModList associated with the beam of the two resourceSetToAddModList according to a total bit number of the number of the HARQ-ACK information, wherein in the case that the PUCCH resource set is first a PUCCH resource set determined from the resourceSetToAddModList associated with the beam and a total number of PUCCH resources in the first PUCCH resource set is larger than 8, the PUCCH resource is determined from all PUCCH resources in the first PUCCH resource set according to a PRI field in a last DCI corresponding to the HARQ-ACK information with corresponding DCI and a CORESET of the last DCI corresponding to the HARQ-ACK information with corresponding DCI; otherwise, the PUCCH resource is determined from all PUCCH resources in the PUCCH resource set associated with the beam according to a PRI field in a last DCI corresponding to the HARQ-ACK information with corresponding DCI.

In some embodiments of the present application, in the case that the UCI multiplexing mode is separate UCI multiplexing, one SPS-PUCCH-AN-List is configured, and a PUCCH resource of the at least one PUCCH resource carries UCI information only including HARQ-ACK information bits in response to a plurality of semi persistent scheduling (SPS) physical downlink shared channel (PDSCH) receptions associated with a beam or only including HARQ-ACK information bits in response to one or more SPS PDSCH receptions associated with a beam and schedule request (SR) associated with the beam, the PUCCH resource is determined from all PUCCH resources associated with the beam of the SPS-PUCCH-AN-List according to a total number of bits of the UCI information.

In some embodiments of the present application, in the case that the UCI multiplexing mode is separate UCI multiplexing, two SPS-PUCCH-AN-Lists are configured, and a PUCCH resource of the at least one PUCCH resource carries UCI information only including HARQ-ACK information bits in response to a plurality of SPS PDSCH receptions associated with a beam or only including HARQ-ACK information bits in response to one or more SPS PDSCH receptions associated with a beam and SR associated with the beam, the PUCCH resource is determined from all PUCCH resources of a SPS-PUCCH-AN-List associated with the beam of the two SPS-PUCCH-AN-Lists according to a total number of bits of the UCI information.

In some embodiments of the present application, in the case that the UCI multiplexing mode is separate UCI multiplexing, one multi-CSI-PUCCH-ResourceList is configured, and a) a plurality of PUCCH resources associated with a beam of the one or more PUCCH resources carrying a plurality of CSI reports are overlapping on the slot where UCI information includes the plurality of CSI reports or b) at least one PUCCH resource associated with a beam of the one or more PUCCH resources carrying at least one CSI report and at least one other PUCCH resource associated with the beam carrying at least one of HARQ-ACK information bits in response to at least one SPS PDSCH reception or SR information bits are overlapping on the slot where the UCI information includes the at least one CSI report and the at least one of HARQ-ACK information or SR information, the at least one PUCCH resource includes a PUCCH resource for multiplexing the UCI information, wherein, the PUCCH resource is determined from all PUCCH resources associated with the beam of the multi-CSI-PUCCH-ResourceList according to a total bit number of the UCI information.

In some embodiments of the present application, in the case that the UCI multiplexing mode is separate UCI multiplexing, two multi-CSI-PUCCH-ResourceLists are configured, and a) a plurality of PUCCH resources associated with a beam of the one or more PUCCH resources carrying a plurality of CSI reports are overlapping on the slot where UCI information includes the plurality of CSI reports or b) at least one PUCCH resource associated with a beam of the one or more PUCCH resources carrying at least one CSI report and at least one other PUCCH resource associated with the beam carrying at least one of HARQ-ACK information bits in response to at least one SPS PDSCH reception or SR information bits are overlapping on the slot where the UCI information includes the at least one CSI report and the at least one of HARQ-ACK information or SR information, the at least one PUCCH resource includes a PUCCH resource for multiplexing the UCI information, wherein, the PUCCH resource is determined from all PUCCH resources of a multi-CSI-PUCCH-ResourceList associated with the beam of the two multi-CSI-PUCCH-ResourceLists according to a total bit number of the UCI information.

In some embodiments of the present application, in the case the UCI multiplexing mode is separate UCI multiplexing, the at least one PUCCH resource is at most 4 PUCCH resources associated with two beams determined after the separate UCI multiplexing, and each beam is associated with at most 2 PUCCH resources of the at most 4 PUCCH resources, the number of PUCCH resources to be transmitted is determined from the at most 4 PUCCH resources is according to a highest UCI priority of each of the at most 4 PUCCH resources.

In some embodiments of the present application, in the case that the UCI multiplexing mode is joint UCI multiplexing, there are a plurality of PUCCH resources on the slot to transmit CSI reports, and the number is equal to or smaller than 2, determining a number of PUCCH resources to be transmitted on the slot from the at least one PUCCH resource includes: determining a first PUCCH resource corresponding to a CSI report with a highest priority in the case that the UE is not provided multi-CSI-PUCCH-ResourceList or PUCCH resources for transmissions of CSI reports associated with a beam do not overlap on the slot, in the case that there is a first set of PUCCH resource on the slot not overlapping with the first PUCCH resource, determining a second PUCCH resource corresponding to a CSI report with a highest priority from the first set of PUCCH resources; in the case that there is a second set of PUCCH resource on the slot overlapping with the first PUCCH resource while associated with another beam different from the first PUCCH resource, determining a third PUCCH resource corresponding to a CSI report with a highest priority from the second set of PUCCH resource on the slot; and determining a PUCCH resource with a higher priority from the second PUCCH resource and the third PUCCH resource as a PUCCH resource to be transmitted, wherein at most one PUCCH resource of the first PUCCH resource and the second PUCCH resource includes PUCCH format 3 or 4, and at most one PUCCH resource of the first PUCCH resource and the third PUCCH resource includes PUCCH format 3 or 4.

In some embodiments of the present application, in the case that the UCI multiplexing mode is joint UCI multiplexing, there are a plurality of PUCCH resources on a slot to transmit CSI reports, and the number is equal to or smaller than 2, determining a number of PUCCH resources to be transmitted from the at least one PUCCH resource includes: determining a first PUCCH resource corresponding to a CSI report with a highest priority in the case that the UE is not provided multi-CSI-PUCCH-ResourceList or PUCCH resources for transmissions of CSI reports associated with a beam do not overlap on the slot, in the case that there is a first set of PUCCH resources on the slot not overlapping with the first PUCCH resource, determining a second PUCCH resource corresponding to a CSI report with a highest priority from the first set of PUCCH resources; in the case that there is a second set of PUCCH resources on the slot overlapping with the first PUCCH resource while associated with another beam different from the first PUCCH resource, determining a third PUCCH resource corresponding to a CSI report with a highest priority from the second set of PUCCH resource on the slot; and determining a PUCCH resource with a higher priority from the second PUCCH resource and the third PUCCH resource as a PUCCH to be transmitted, wherein at most one PUCCH resource of the first PUCCH resource and the second PUCCH resource includes PUCCH format 3 or 4.

In some embodiments of the present application, in the case that ackNackFeedbackMode is configured as separate and two CORESETPoolIndex values are configured, the UCI multiplexing mode is separate UCI multiplexing.

In some embodiments of the present application, in the case that ackNackFeedbackMode is configured as separate and two CORESETPoolIndex values are configured, a PUCCH resource carrying HARQ-ACK information with corresponding DCI associated with different CORESETPoolIndex values are not expected to be overlapped.

Some yet other embodiments of the present application also proposes another apparatus of uplink transmission, e.g., a radio access network (RAN) node, which may include: a transceiver; and a processor coupled to the transceiver, wherein the processor is configured to: transmit information indicating one or more PUCCH resources which are expected to be transmitted on a slot; and receive a number of PUCCH resources, wherein the number of PUCCH resource is determined from at least one PUCCH resource determined based on the one or more PUCCH resources and an UCI mode in a UE side and is equal to or smaller than a configured or predefined maximum number, and there is no overlapping PUCCH resources associated with a same beam in the number of PUCCH resources.

Embodiments of the present application provide a technical solution of uplink transmission, enhancing PUCCH transmission in scenarios of multiple panel simultaneous UL transmission and increasing efficiency of UL transmission, especially in common beam framework, and thus will facilitate the implementation of NR.

### BRIEF DESCRIPTION OF THE DRAWINGS

In order to describe the manner in which advantages and features of the application can be obtained, a description of the application is rendered by reference to specific embodiments thereof, which are illustrated in the appended drawings. These drawings depict only example embodiments of the application and are not therefore to be considered limiting of its scope.

FIG. 1 is a schematic diagram illustrating an exemplary wireless communication system according to an embodiment of the present application.

FIG. 2 illustrates a flow chart of a method of uplink transmission according to some embodiments of the present application.

FIG. 3 illustrates a block diagram of an apparatus of uplink transmission according to some embodiments of the present application.

FIG. 4 illustrates a block diagram of an apparatus of uplink transmission according to some other embodiments of the present application.

### DETAILED DESCRIPTION

The detailed description of the appended drawings is intended as a description of preferred embodiments of the present application, and is not intended to represent the only form in which the present application may be practiced. It should be understood that the same or equivalent functions may be accomplished by different embodiments that are intended to be encompassed within the spirit and scope of the present application.

Reference will now be made in detail to some embodiments of the present application, examples of which are illustrated in the accompanying drawings. To facilitate understanding, embodiments are provided under specific network architecture and new service scenarios, such as 3rd generation partnership project (3GPP) 5G, 3GPP long term evolution (LTE) Release 8 and so on. It is contemplated that along with the developments of network architectures and new service scenarios, all embodiments in the present application are also applicable to similar technical problems. Moreover, the terminologies recited in the present application may change, which should not affect the principle of the present application.

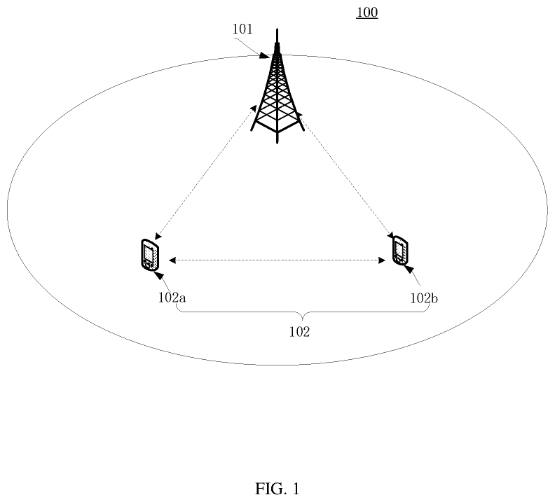

FIG. 1 illustrates a schematic diagram of an exemplary wireless communication system 100 according to some embodiments of the present application.

As shown in FIG. 1, the wireless communication system 100 includes at least one BS 101 and at least one UE 102. In particular, the wireless communication system 100 includes one BS 101 and two UE 102 (e.g., a UE 102a and UE 102b) for illustrative purpose. Although a specific number of BSs and UEs are illustrated in FIG. 1 for simplicity, it is contemplated that the wireless communication system 100 may include more or less BSs and UEs in some other embodiments of the present application.

The wireless communication system 100 is compatible with any type of network that is capable of sending and receiving wireless communication signals. For example, the wireless communication system 100 is compatible with a wireless communication network, a cellular telephone network, a time division multiple access (TDMA)-based network, a code division multiple access (CDMA)-based network, an orthogonal frequency division multiple access (OFDMA)-based network, an LTE network, a 3GPP-based network, a 3GPP 5G network, a satellite communications network, a high altitude platform network, and/or other communications networks.

The BS 101 may communicate with a core network (CN) node (not shown), e.g., a mobility management entity (MME) or a serving gateway (S-GW), a mobility management function (AMF) or a user plane function (UPF) etc. via an interface. A BS also be referred to as an access point, an access terminal, a base, a macro cell, a node-B, an enhanced node B (eNB), a gNB, a home node-B, a relay node, or a device, or described using other terminology used in the art. In 5G NR, a BS may also refer to as a radio access network (RAN) node. Each BS may serve a number of UE(s) within a serving area, for example, a cell or a cell sector via a wireless communication link. Neighbor BSs may communicate with each other as necessary, e.g., during a handover procedure for a UE.

In addition, a BS 101 may be configured with one TRP (or panel), i.e., in a single-TRP scenario or more TRPs (or panels), i.e., a multi-TRP scenario. That is, one or more TRPs are associated with the BS 101. A TRP can act like a small BS. A single TRP can be used to serve one or more UE 103 under the control of a BS 101. In different scenarios, a TRP may be referred to as different terms, which may be represented by a TCI state index or CORESETPoolIndex value etc. It should be understood that the TRP(s) (or panel(s)) configured for the BS 101 may be transparent to a UE 102. Two TRPs can have the same cell ID (identity or index) or different cell IDs. Two TRPs can communicate with each other by a backhaul link. Such a backhaul link may be an ideal backhaul link or a non-ideal backhaul link. Latency of the ideal backhaul link may be deemed as zero, and latency of the non-ideal backhaul link may be tens of milliseconds and much larger, e.g. on the order of tens of milliseconds, than that of the ideal backhaul link.

The UE 102, e.g., the UE 102a and UE 102b may include computing devices, such as desktop computers, laptop computers, personal digital assistants (PDAs), tablet computers, smart televisions (e.g., televisions connected to the Internet), set-top boxes, game consoles, security systems (including security cameras), vehicle on-board computers, network devices (e.g., routers, switches, and modems), or the like. According to an embodiment of the present application, the UE may include a portable wireless communication device, a smart phone, a cellular telephone, a flip phone, a device having a subscriber identity module, a personal computer, a selective call receiver, or any other device that is capable of sending and receiving communication signals on a wireless network. In some embodiments, the UE may include wearable devices, such as smart watches, fitness bands, optical head-mounted displays, or the like. Moreover, the UE may be referred to as a subscriber unit, a mobile, a mobile station, a user, a terminal, a mobile terminal, a wireless terminal, a fixed terminal, a subscriber station, a user terminal, or a device, or described using other terminology used in the art.

According to legacy specifications, at most two non-overlapping PUCCH resources can be transmitted on a slot. When two PUCCH resources are determined to be transmitted, at least one short PUCCH resource is included except that each of the two PUCCH resources carries at least HARQ-ACK information (or HARQ-ACK, or HARQ-ACK information bits), which means two long PUCCH resources can be transmitted on a slot. Regarding a short PUCCH resource, it refers to a PUCCH resource including PUCCH format 0 or PUCCH format 2 (or PUCCH resource with PUCCH format 0 or PUCCH format 2), which may have a duration of 1 to 2 symbols. Regarding a long PUCCH resource, it refers to a PUCCH resource including PUCCH format 1, PUCCH format 3 or PUCCH format 4 (or PUCCH resource with PUCCH format 1, PUCCH format 3 or PUCCH format 4), which may have a duration of 4 to 14 symbols.

In the case that there are PUCCH resources carrying only CSI reports (each PUCCH resource carrying one CSI report) on a slot, if multi-CSI-PUCCH-ResourceList is not configured, at most two non-overlapping PUCCH resources will be selected to be transmitted while at most 1 long PUCCH resource is selected; while, if multi-CSI-PUCCH-ResourceList is configured, one PUCCH resource from the multi-CSI-PUCCH-ResourceList will be selected according to the total CSI payload size on the slot. In addition, if multi-CSI-PUCCH-ResourceList is configured, when one or more PUCCH resources carrying CSI reports overlap with at least one PUCCH resource carrying at least one of: HARQ-ACK information bits in response to at least one SPS PDSCH reception or SR (hereafter, HARQ-ACK of SPS PDSCH/SR), one PUCCH resource will be selected from the multi-CSI-PUCCH-ResourceList according to the UCI information bits of the CSI reports and HARQ-ACK of SPS PDSCH/SR.

If a PUCCH resource carrying HARQ-ACK information bits (which is determined by the total number of the HARQ-ACK information bits and PRI field in the corresponding DCI) is overlapped with other PUCCH resource(s), a new PUCCH resource (same or different from the overlapped PUCCH resources) will be determined according to the total UCI bits of HARQ-ACK information and UCIs on the other PUCCH resource(s) and the PRI field.

If the UE is provided a SPS-PUCCH-AN-List and transmits O_{UCI} UCI information bits that include only HARQ-ACK of SPS PDSCH/SR, a PUCCH resource will be selected from the SPS-PUCCH-AN-List according to the UCI payload size (bit number).

In Rel-18, multiple panel simultaneous UL transmission will be discussed, which may be supported for S-DCI and M-DCI based M-TRP. For example, (PUCCH+PUCCH) will be supported for M-DCI based M-TRP. Therefore, two overlapping PUCCH resources associated with different panels/TRPs can be transmitted simultaneously. Besides, common beam framework will be applied for multiple panel simultaneous UL transmission if it is supported. Regarding a beam, it can also be represented in various manners, e.g., TCI state, spatial domain filter, or a reference signal etc. One PUCCH resource can be indicated to be associated with one common beam based on common beam framework, and thus, two PUCCH resources associated with two different common beams can be identified to be associated with two panels/TRPs respectively.

In order to utilize the capability of multiple panel simultaneous UL transmission, UCI multiplexing on PUCCH resources can be performed per TRP. When UCI on different PUCCH resources is multiplexed, a new PUCCH resource may be determined according to the total payload size of the multiplexed UCI. Therefore, it is possible that when multiplexing UCI on different PUCCH resources associated with one panel/TRP, a new PUCCH resource associated with the other panel/TRP is determined according to the legacy multiplexing rule. Therefore, legacy UCI multiplexing rule must be enhanced when UCI multiplexing is performed per TRP.

Besides, as stated above, according to legacy specifications, a UE can only transmit at most two PUCCH resources on a slot where only two long PUCCH resources are supported if each of the two PUCCH resources carries at least HARQ-ACK information; otherwise, at least one short PUCCH resource will be included in two selected PUCCH resources. However, whether the related PUCCH transmission capability of the UE will be enhanced or unchanged when UCI multiplexing per TRP is performed has not been discussed yet. How to select the transmitted PUCCH resources after UCI multiplexing per TRP should also be solved.

At least to solve the above technical problems, embodiments of the present application propose a technical solution of uplink transmission, which specifies an enhanced UCI multiplexing rule, and also improve selection (or determination) of the PUCCH resources to be transmitted after UCI multiplexing per TRP.

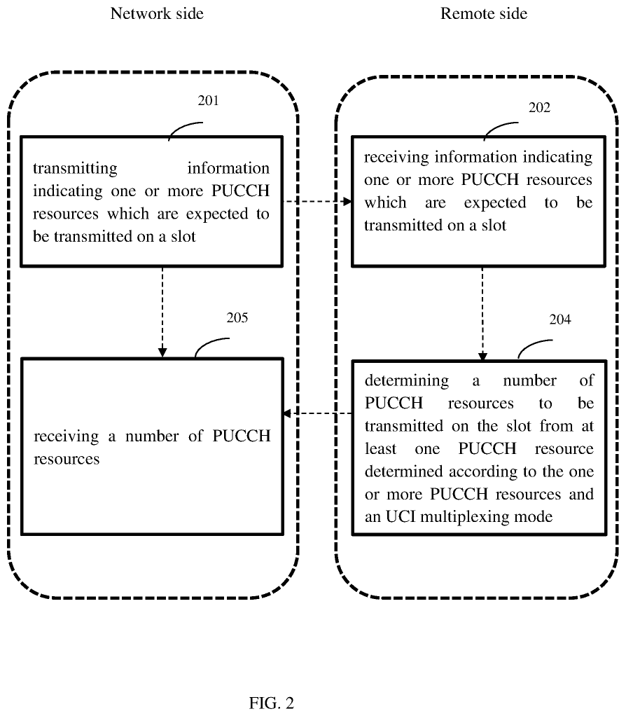

FIG. 2 illustrates a flow chart of a method of uplink transmission according to some embodiments of the present application. Although the method is illustrated in a system level by a UE in a remote side (or UE side) and a RAN node, e.g., a gNB in a network side (or BS side), persons skilled in the art can understand that the method implemented in the remote side and that implemented in the network side can be separately implemented and incorporated by other apparatus with similar functions. In addition, no transmission or reception failure is considered in the illustrated embodiments of the present application.

Referring to FIG. 2, the network side, e.g., a gNB will transmit information indicating one or more PUCCH resources which are expected to be transmitted on a slot in step 201. For example, the gNB may configure one or more PUCCH resources to be transmitted on a slot for the UE by RRC signaling, e.g., one or more PUCCH resources for one or more CSI reports to be transmitted on a slot, or for HARQ-ACK information in response to one or more SPS PDSCH to be transmitted on a slot, or for SR to be transmitted on a slot. In another example, the gNB may schedule one or more PUCCH resources to be transmitted on a slot for the UE by DCI, e.g., one or more PUCCH resources for HARQ-ACK information with corresponding DCI. In yet another example, the one or more PUCCH resources may include PUCCH resources for different types of UCI by RRC signaling and/or DCI, e.g., at least one PUCCH resource for at least one CSI report, and/or at least one PUCCH for HARQ-ACK of SPS PDSCH/SR, and/or least one PUCCH for HARQ-ACK information with corresponding DCI.

Herein (throughout the specification), it is always supposed that UE supports multiple panel simultaneous UL transmission. For example, the UE can simultaneously transmit multiple PUCCH resources with different beams according to a RRC parameter or UE's capability report. If it is indicated by the RRC parameter, the UE must report that it is capable to perform multi-panel simultaneous UL transmission firstly.

Accordingly, in step 202, the UE will receive the information indicating the one or more PUCCH resources which are expected to be transmitted on a slot. In step 204, the UE will determine a number of PUCCH resources to be transmitted on the slot from at least one PUCCH resource, which is determined according to the one or more PUCCH resources and an UCI multiplexing mode. Consistently, in the network side, the gNB will receive the number of PUCCH resources in step 205 (only PUCCH transmission is considered without considering conflict with other UL resources; otherwise, the number of PUCCH resources received in the network side may be part of all of the number of PUCCH resources determined in the UE side). The number of PUCCH resources is equal to or smaller than a maximum number, e.g., Nₘₐₓ, which may be configured, e.g., by RRC signalling or predefined in 3GPP specification. In addition, there is no overlapping PUCCH resources associated with the same beam in the number of PUCCH resources. For example, when UCI multiplexing on PUCCH resource is performed per TRP, at most 2 non-overlapping PUCCH resources per TRP will be determined according to the one or more PUCCH resources expected to be transmitted on the slot and the UCI multiplexing mode, which means at most 2 non-overlapping PUCCH resources associated with one TRP (or a common beam under common beam frame) will be determined. Accordingly, in the case of two TRPs (or two common beams), at most 4 PUCCH resources will be determined based on the one or more PUCCH resources expected to be transmitted on the slot and the UCI multiplexing mode, and Nₘₐₓ can be configured or predefined to be not smaller than 2 and not larger than 4.

Regarding the UCI multiplexing mode, two UCI multiplexing modes, e.g., separate UCI multiplexing mode (UCI multiplexing per TRP) or joint UCI multiplexing mode (joint UCI multiplexing for both two TRPs) will be illustrated in embodiments of the present application. A UE may be configured with one of the two UCI multiplexing modes, e.g., by RRC or is fixed with one mode of the two UCI multiplexing modes according to some other configurations such as ackNackFeedbackMode etc. According to Rel-16 multi-DCI based multi-TRP, there are two modes for HARQ-ACK feedback, i.e., separate feedback mode and joint feedback mode. According to some embodiments of the present application, in the case that ackNackFeedbackMode is configured as separate and two CORESETPoolIndex values are configured, the UCI multiplexing mode is separate UCI multiplexing. That is, UE is not expected to be configured or fixed as joint UCI multiplexing if ackNackFeedbackMode is separate and two CORESETPoolIndex values are configured.

More detailed embodiments of the present application will be illustrated in the following in view of the two UCI multiplexing modes. Persons skilled in the art should well know that all the configuration fields and/or parameters, e.g., ackNackFeedbackMode, resourceSetToAddModList, SPS-PUCCH-AN-List, and multi-CSI-PUCCH-ResourceList etc. are common known in legacy specifications, while may evolve into other terms as the evolution of 3GPPP. Thus, the name of such configuration fields and/or parameters should not be used to unduly limit the scope of the present application, and should be reasonably interpreted with their technical substance.

### Scenario 1: Separate UCI Multiplexing Mode-UCI Multiplexing Per TRP

In scenarios of separate UCI multiplexing mode, UCI multiplexing is performed per TRP. A PUCCH resource can be associated with a beam which is associated with a TRP. For example, in the common beam frame, a PUCCH resource is associated with one common beam which is associated with a TRP, which can be indicated by a DCI, a media access control (MAC) control element (CE) or RRC signaling. All PUCCH resources associated with the same beam on a slot will be selected to perform the UCI multiplexing.

Since there are various UCI multiplexing cases in view of different UCI, detailed UCI multiplexing schemes may be different in different cases when UCI multiplexing on PUCCH resource is performed per TRP.

Case 1-1: UCI at Least Including HARQ-ACK Information with Corresponding DCI

According to the legacy specification on TS38.213 Section 9.2.5,
“A UE that
   is not provided coresetPoolIndex or is provided coresetPoolIndex with a value of 0 for first CORESETs on active DL BWPs of serving cells, and
   is provided coresetPoolIndex with a value of 1 for second CORESETs on active DL BWPs of the serving cells, and
   is provided ackNackFeedbackMode=separate
does not expect a PUCCH or a PUSCH transmission triggered by a detection of a DCI format in a PDCCH received in a CORESET from the first CORESETs to overlap in time with a PUCCH or a PUSCH transmission triggered by a detection of a DCI format in a PDCCH received in a CORESET from the second CORESETs.”

Thus, in legacy technology, PUCCH resources carrying HARQ-ACK information with corresponding DCI associated with different CORESETPoolIndex values (different TRPs) are not expected to be overlapped if ackNackFeedbackMode is separate, and should follow some limitations. However, when a UE supports multiple panel simultaneous UL transmission, the HARQ-ACK information with corresponding DCI associated with different CORESETPoolIndex values will be carried by different PUCCH resources which can be simultaneously transmitted. Thus, if separate UCI multiplexing is applied for UE supporting multiple panel UL simultaneous transmission, it is no need to follow the legacy limitation. In Case 1-1, embodiments of the present application propose two UCI multiplexing schemes in view of one or two resourceSetToAddModLists being configured.

For example, according to some embodiments of the present application, one resourceSetToAddModList is configured for PUCCH resource configuration. An exemplary resourceSetToAddModList may include at most 4 PUCCH resource sets associated with two CORESETPoolIndex values (TRPs), which are configured for HARQ-ACK information with corresponding DCI on a bandwidth part (BWP) of a cell for a UE. Each PUCCH resource set includes PUCCH resources associated with different beams (each beam associated with a TRP), e.g., PUCCH resources associated with a first beam of two common beams and PUCCH resources associated with a second beam of the two common beams.

First, to multiplex HARQ-ACK information with corresponding DCI associated with a beam on a slot, a PUCCH resource (same or different from a PUCCH resource expected to be transmitted indicated by the network side) for carrying HARQ-ACK information with corresponding DCI associated with a beam (e.g., one of two common beams) can be determined from a PUCCH resource set determined from the resourceSetToAddModList according to a total bit number of the HARQ-ACK information. For each beam, at most one PUCCH resource for carrying HARQ-ACK information with corresponding DCI can be determined.

In the case that the PUCCH resource set is a first PUCCH resource set determined from the resourceSetToAddModList and a total number of PUCCH resources associated with the beam in the first PUCCH resource set is larger than 8, the PUCCH resource is determined from all PUCCH resources associated with the beam in the first PUCCH resource set according to a PRI field in a last DCI corresponding to the HARQ-ACK information with corresponding DCI and CORESET of the last DCI corresponding to the HARQ-ACK information with corresponding DCI. Otherwise, the PUCCH resource is determined from all PUCCH resources associated with the beam in the PUCCH resource set according to a PRI field in a last DCI corresponding to the HARQ-ACK information with corresponding DCI.

The PUCCH resource carrying HARQ-ACK information with corresponding DCI associated with a beam may overlap with other PUCCH resource(s) carrying other UCI information on a slot. For example, the PUCCH resource carrying HARQ-ACK information with corresponding DCI associated with a beam may overlap with at least one PUCCH resource carrying CSI report associated with the same beam on a slot, or overlap with at least one PUCCH resource carrying HARQ-ACK of SPS PDSCH and/or SR associated with the same beam on a slot, or overlap with at least one PUCCH resource carrying CSI report associated with the same beam and at least one PUCCH resource carrying HARQ-ACK of SPS PDSCH and/or SR associated with the same beam on a slot.

Similarly, in the case that one PUCCH resource carrying HARQ-ACK information with corresponding DCI associated with a beam is overlapping with at least one other PUCCH resource carrying other UCI information associated with the beam on a slot, a PUCCH resource associated with the beam (same or different from the overlapped PUCCH resources) will be determined from a PUCCH resource set determined from the resourceSetToAddModList according to a total bit number of the HARQ-ACK information and the other UCI information.

In the case that the PUCCH resource set is a first PUCCH resource set determined from the resourceSetToAddModList and a total number of PUCCH resources associated with the beam in the first PUCCH resource set is larger than 8, the PUCCH resource for multiplexing the HARQ-ACK information and the other UCI information is determined from all PUCCH resources associated with the beam in the first PUCCH resource set according to a PRI field in a last DCI corresponding to the HARQ-ACK information with corresponding DCI and a CORESET of the last DCI corresponding to the HARQ-ACK information with corresponding DCI. Otherwise, the PUCCH resource for multiplexing the HARQ-ACK information and the other UCI information is determined from all PUCCH resources associated with the beam in the PUCCH resource set according to a PRI field in a last DCI corresponding to the HARQ-ACK information with corresponding DCI.

According to legacy specification, at most 8 PUCCH resources can be configured for a PUCCH resource set except for the first PUCCH resource set, and the PRI field has at most 3 bits to indicate one PUCCH resource from a PUCCH resource set. Thus, when only one resourceSetToAddModList is configured for PUCCH resource configuration and different PUCCH resources in the same PUCCH resource set are associated with different beams (e.g., two common beams), it may need to increase the PUCCH resource number of each PUCCH resource set considering the UCI multiplexing per TRP and the flexibility of PUCCH resource selection.

According to some other embodiments of the present application, two resourceSetToAddModLists can be configured for PUCCH resource configuration. For example, in scenarios of M-DCI based M-TRP, two resourceSetToAddModLists, each indicating at most 4 PUCCH resource sets for HARQ-ACK information with corresponding DCI per CORESETPoolIndex value (TRP) can be configured for a UE on a BWP of a cell. Since each common beam is associated with one CORESETPoolIndex value in M-DCI based M-TRP, each PUCCH resource set configured for a UE is associated with one common beam.

To multiplex HARQ-ACK information with corresponding DCI associated with a beam on a slot, a PUCCH resource (same or different from a PUCCH resource expected to be transmitted indicated by the network side) for carrying HARQ-ACK information with corresponding DCI associated with a beam (e.g., one of two common beams) can be determined from a PUCCH resource set determined from a resourceSetToAddModList associated with the beam of the two resourceSetToAddModLists according to a total bit number of the HARQ-ACK information. For each beam, at most one PUCCH resource for carrying HARQ-ACK information with corresponding DCI can be determined.

In the case that the PUCCH resource set is a first PUCCH resource set determined from the resourceSetToAddModList associated with the beam (e.g., the first beam) and a total number of PUCCH resources in the first PUCCH resource set is larger than 8, the PUCCH resource is determined from all PUCCH resources in the first PUCCH resource set according to a PRI field in a last DCI corresponding to the HARQ-ACK information with corresponding DCI and a CORESET of the last DCI corresponding to the HARQ-ACK information with corresponding DCI. Otherwise, the PUCCH resource is determined from all PUCCH resources in the PUCCH resource set associated with the beam according to a PRI field in a last DCI corresponding to the HARQ-ACK information with corresponding DCI.

Similarly, in the case that one PUCCH resource carrying HARQ-ACK information with corresponding DCI associated with a beam is overlapping with at least one other PUCCH resource carrying other UCI information associated with the beam on a slot, a PUCCH resource associated with the beam (same or different from the overlapped PUCCH resources) will be determined from a PUCCH resource set determined from a resourceSetToAddModList associated with the beam of the two resourceSetToAddModLists according to a total bit number of the HARQ-ACK information and the other UCI information.

In the case that the PUCCH resource set is a first PUCCH resource set determined from the resourceSetToAddModList associated with the beam and a total number of PUCCH resources in the first PUCCH resource set is larger than 8, the PUCCH resource is determined from all PUCCH resources in the first PUCCH resource set according to a PRI field in a last DCI corresponding to the HARQ-ACK information with corresponding DCI and a CORESET of the last DCI corresponding to the HARQ-ACK information with corresponding DCI. Otherwise, the PUCCH resource is determined from all PUCCH resources in the PUCCH resource set associated with the beam according to a PRI field in a last DCI corresponding to the HARQ-ACK information with corresponding DCI.

When two resourceSetToAddModLists are configured for PUCCH resource configuration, the corresponding RRC configuration of PUCCH in TS38.331 can be updated, e.g., as follows:

| - | PUCCH-Config ::= | SEQUENCE { |
|---|---|---|
| - | resourceSetToAddModList1 | SEQUENCE (SIZE |
| | (1..maxNrofPUCCH-ResourceSets)) OF PUCCH-ResourceSet | |
| | OPTIONAL, -- Need N | |
| - | resourceSetToReleaseList1 | SEQUENCE (SIZE |
| | (1..maxNrofPUCCH-ResourceSets)) OF PUCCH-ResourceSetId | |
| | OPTIONAL, -- Need N | |
| - | resourceSetToAddModList2 | SEQUENCE (SIZE |
| | (1..maxNrofPUCCH-ResourceSets)) OF PUCCH-ResourceSet | |
| | OPTIONAL, -- Need N | |
| - | resourceSetToReleaseList2 | SEQUENCE (SIZE |

| | |
|---|---|
| | (1..maxNrofPUCCH-ResourceSets)) OF PUCCH-ResourceSetId |
| | OPTIONAL, -- Need N |
| - | -------------------------------other unchanged parts are |
| | omitted--------------------------------- |
| - | } |
| - | |

Wherein, resourceSetToAddModList1 and resourceSetToReleaseList1 are associated with CORESETPoolIndex 0 which is associated with a first common beam, and resourceSetToAddModList2 and resourceSetToReleaseList2 are associated with CORESTPoolIndex 1 which is associated with the second common beam. Accordingly, a PUCCH resource for carrying HARQ-ACK information with corresponding DCI associated with a beam (e.g., a first beam of two common beams) can be determined from a resourceSetToAddModList associated with the beam (e.g., resourceSetToAddModList1 associated with the first beam) of the two resourceSetToAddModLists, i.e., resourceSetToAddModList1 and esourceSetToAddModList2 according to the total bit number of the HARQ-ACK information. In addition, in some other embodiments of the present application, resourceSetToAddModList1 may still use the same expression in legacy specification, i.e., resourceSetToAddModList. Persons skilled in the art should well know that in this case the “resourceSetToAddModList” in the RRC configuration is only one specific configuration instance and should not be interpreted into only one resourceSetToAddModList being configured.

### Case 1-2: UCI Only Including HARQ-ACK of SPS PDSCH and SR if any

In Case 1-2, UCI information bits, represented by OuCI, which include HARQ-ACK information bits in response to one or more SPS PDSCH receptions and SR (if any) associated with a same common beam will be determined firstly. For example, per TRP, the UCI information to be determined include: HARQ-ACK information bits in response to one or more SPS PDSCH receptions, which are associated with one common beam according to the activated DCI of the SPS PDSCH; and SR (if any) associated with one common beam according to the common beam of a PUCCH resource configured for the SR.

Similar to Case 1-1, for multiplexing UCI information associated with a beam which only includes HARQ-ACK information bits in response to one or more SPS PDSCH receptions and SR (if any) associated with the beam, embodiments of the present application propose two UCI multiplexing schemes in view of one or two SPS-PUCCH-AN-Lists being configured.

According to some embodiments of the present application, one SPS-PUCCH-AN-List is configured. To multiplex UCI information associated with a beam on a slot, which only includes HARQ-ACK of SPS PDSCH and SR (if any) associated with the beam, a PUCCH resource (same or different from a PUCCH resource expected to be transmitted indicated by the network side) associated with the beam can be determined from all PUCCH resources associated with the beam of the SPS-PUCCH-AN-List according to a total number of bits of the UCI information.

For example, the PUCCH resource for carrying the HARQ-ACK of SPS PDSCH and SR (if any) will be obtained (or determined) from the first entry of all entries indicating the PUCCH resources associated with the same common beam in the SPS-PUCCH-AN-List, if O_{UCI}≤2 including 1 or 2 HARQ-ACK information bits and a positive or negative SR on one SR transmission occasion if transmission of HARQ-ACK information and SR occurs simultaneously.

The PUCCH resource for carrying the HARQ-ACK of SPS PDSCH and SR (if any) will be obtained from the second entry of all entries indicating the PUCCH resources associated with the same common beam in SPS-PUCCH-AN-List, if 2<O_{UCI}≤N_{1,SPS} where N_{1,SPS} is either provided by maxPayloadSize obtained from the second entry in SPSPUCCH-AN-List or is otherwise equal to 1706.

The PUCCH resource for carrying the HARQ-ACK of SPS PDSCH and SR (if any) will be obtained from the third entry of all entries indicating the PUCCH resources associated with the same common beam in SPS-PUCCH-AN-List, if N_{1,SPS}<O_{UCI}≤N_{2,SPS} where N_{2,SPS} is either provided by maxPayloadSize obtained from the third entry in SPS-PUCCH-AN-List or is otherwise equal to 1706.

The PUCCH resource for carrying the HARQ-ACK of SPS PDSCH and SR (if any) will be obtained from the fourth entry of all entries indicating the PUCCH resources associated with the same common beam in SPS-PUCCH-AN-List, if N_{2,SPS}<O_{UCI}≤N_{3,SPS} where N_{3,SPS} is equal to 1706.

For example, 8 PUCCH resources are configured in an exemplary SPS-PUCCH-AN-List, wherein the first 4 PUCCH resources in the SPS-PUCCH-AN-List are associated with a first common beam, and the last 4 PUCCH resources in the SPS-PUCCH-AN-List are associated with a second common beam. Then, if O_{UCI} UCI information bits which only include HARQ-ACK of SPS PDSCH and SR (if any) associated with the first common beam, the first PUCCH resource in the SPS-PUCCH-AN-List is determined if O_{UCI}≤2 because it is the first PUCCH resource associated with the first common beam in the SPS-PUCCH-AN-List. If O_{UCI} UCI information bits which only include HARQ-ACK of SPS PDSCH and SR (if any) associated with the second common beam, the fifth PUCCH resource in the SPS-PUCCH-AN-List is determined if O_{UCI}≤2 because it is the first PUCCH resource associated with the second common beam in the SPS-PUCCH-AN-List.

According to some other embodiments of the present application, two SPS-PUCCH-AN-Lists are configured. To multiplex UCI information on a slot, which only includes HARQ-ACK of SPS PDSCH and SR (if any), a PUCCH resource (same or different from a PUCCH resource expected to be transmitted indicated by the network side) can be determined from all PUCCH resources of a SPS-PUCCH-AN-List associated with the beam of the two SPS-PUCCH-AN-Lists according to a total number of bits of the UCI information.

For example, in scenarios of M-DCI based M-TRP, two SPS-PUCCH-AN-Lists are configured on a BWP of a cell for a UE, each of the two SPS-PUCCH-AN-Lists are associated with one CORESETPoolIndex value of two CORESETPoolIndex values. All PUCCH resources in each SPS-PUCCH-AN-List are associated with one CORESETPoolIndex value and further associated with one same common beam because one common beam is associated with one CORESETPoolIndex value in M-DCI based M-TRP. Then, the UE can determine a PUCCH resource for O_{UCI} UCI information bits only including HARQ-ACK of SPS PDSCH and SR (if any) associated with a common beam as follows.

The PUCCH resource for carrying the HARQ-ACK of SPS PDSCH and SR (if any) will be obtained from the first entry in a SPS-PUCCH-AN-List associated with the same common beam if O_{UCI}≤2 including 1 or 2 HARQ-ACK information bits and a positive or negative SR on one SR transmission occasion if transmission of HARQ-ACK information and SR occurs simultaneously.

The PUCCH resource for carrying the HARQ-ACK of SPS PDSCH and SR (if any) will be obtained from the second entry in a SPS-PUCCH-AN-List associated with the same common beam, if provided, if 2<O_{UCI}≤N_{1,SPS} where N_{1,SPS} is either provided by maxPayloadSize obtained from the second entry in sps-PUCCH-AN-List or is otherwise equal to 1706.

The PUCCH resource for carrying the HARQ-ACK of SPS PDSCH and SR (if any) will be obtained from the third entry in a SPS-PUCCH-AN-List associated with the same common beam, if N_{1,SPS}<O_{UCI}≤N_{2,SPS} where N_{2,SPS} is either provided by maxPayloadSize obtained from the third entry in sps-PUCCH-AN-List or is otherwise equal to 1706.

The PUCCH resource for carrying the HARQ-ACK of SPS PDSCH and SR (if any) will be obtained from the fourth entry in a SPS-PUCCH-AN-List associated with the same common beam, if N_{2,SPS}<O_{UCI}≤N_{3,SPS} where N_{3,SPS} is equal to 1706.

Similarly, when two SPS-PUCCH-AN-Lists are configured for PUCCH resource configuration, the corresponding RRC configuration of PUCCH in TS38.331 can be updated, e.g., as follows:

| | |
|---|---|
| PUCCH-Config ::= | SEQUENCE { |
| resourceSetToAddModList | SEQUENCE (SIZE |
| (1..maxNrofPUCCH-ResourceSets)) OF PUCCH-ResourceSet | OPTIONAL, |

-- Need N

| | |
|---|---|
| resourceSetToReleaseList | SEQUENCE (SIZE |
| (1..maxNrofPUCCH-ResourceSets)) OF PUCCH-ResourceSetId | OPTIONAL, -- |

Need N
-------------------------------other unchanged parts are
omitted---------------------------------

| | |
|---|---|
| sps-PUCCH-AN-List1-r16 | SetupRelease |
| { SPS-PUCCH-AN-List-r16 } | OPTIONAL, -- |

Need M

| | |
|---|---|
| sps-PUCCH-AN-List2 | SetupRelease |
| { SPS-PUCCH-AN-List-r16 } | OPTIONAL, -- |

Need M
-------------------------------other unchanged parts are
omitted---------------------------------
}

Wherein, sps-PUCCH-AN-List1-r16 is associated with CORESETPoolIndex 0 (first TRP) which is associated with a first common beam, and sps-PUCCH-AN-List2 is associated with CORESTPoolIndex 1 (second TRP) which is associated with the second common beam. If the O_{UCI} UCI information bits are associated with the first common beam and CORESETPoolIndex 0, then a PUCCH resource on sps-PUCCH-AN-List1-r16 will be selected according to O_{UCI} UCI information bits. If the O_{UCI} UCI information bits are associated with the second common beam and CORESETPoolIndex 1, then a PUCCH resource on sps-PUCCH-AN-List2 will be selected according to O_{UCI} UCI information bits.
Case 1-3: UCI Including CSI Report(s) and HARQ-ACK of SPS PDSCH and/or SR if any

In Case 1-3, the UCI to be multiplexed on a slot associated with a beam includes CSI report(s) and HARQ-ACK of SPS PDSCH and/or SR (if any) associated with a beam. In an exemplary scenario, a plurality of PUCCH resources associated with a beam carrying a plurality of CSI reports are overlapping on the slot, wherein the UCI information includes the plurality of CSI reports. In another exemplary scenario, at least one PUCCH resource associated with a beam carrying at least one CSI report and at least one other PUCCH resource associated with the beam carrying HARQ-ACK of SPS PDSCH and/or SR are overlapping on the slot, wherein the UCI information includes the at least one CSI report and the HARQ-ACK of SPS PDSCH and/or SR.

Similar to Case 1-1, for multiplexing UCI information associated with a beam which includes CSI report(s) and HARQ-ACK of SPS PDSCH and/or SR (if any) associated with the beam, embodiments of the present application propose two UCI multiplexing schemes in view of one or two multi-CSI-PUCCH-ResourceLists being configured.

According to some embodiments of the present application, one multi-CSI-PUCCH-ResourceList is configured. To multiplex the UCI information associated with a beam in Case 1-3, a PUCCH resource associated with the beam will be determined from all PUCCH resources associated with the beam of the multi-CSI-PUCCH-ResourceList according to a total bit number of the UCI information.

According to some embodiments of the present application, at most two PUCCH resources can be configured in a multi-CSI-PUCCH-ResourceList. Thus, the maximum number PUCCH of resources configured in the multi-CSI-PUCCH-ResourceList may be increased to ensure the flexibility of UCI multiplexing per TRP/panel. For example, in common beam frame, 4 PUCCH resources can be configured in multi-CSI-PUCCH-ResourceList where the first two PUCCH resources are associated with the first common beam, and the last 2 PUCCH resources are associated with the second common beam. If the multiplexed UCI bits are associated with the first common beam, then the first or second PUCCH resource is determined according to the UCI bits for the UCI multiplexing. If the multiplexed UCI bits are associated with the second common beam, then the third or fourth PUCCH resource is determined according to the UCI bits for the UCI multiplexing.

According to some other embodiments of the present application, two multi-CSI-PUCCH-ResourceLists are configured. To multiplex the UCI information associated with a beam in Case 1-3, a PUCCH resource associated with a beam will be determined from all PUCCH resources of a multi-CSI-PUCCH-ResourceList associated with the beam of the two multi-CSI-PUCCH-ResourceLists.

Similarly, when two multi-CSI-PUCCH-ResourceLists are configured for PUCCH resource configuration, the corresponding RRC configuration of PUCCH in TS38.331 can be updated, e.g., as follows:

| | |
|---|---|
| PUCCH-Config ::= | SEQUENCE { |
| resourceSetToAddModList | SEQUENCE (SIZE |
| (1..maxNrofPUCCH-ResourceSets)) OF PUCCH-ResourceSet | OPTIONAL, |

-- Need N

| | |
|---|---|
| resourceSetToReleaseList | SEQUENCE (SIZE |
| (1..maxNrofPUCCH-ResourceSets)) OF PUCCH-ResourceSetId | OPTIONAL, -- |

Need N
-------------------------------other unchanged parts are
omitted---------------------------------

| | |
|---|---|
| multi-CSI-PUCCH-ResourceList1 | SEQUENCE (SIZE (1..2)) |
| OF PUCCH-ResourceId | OPTIONAL, -- Need M |
| multi-CSI-PUCCH-ResourceList2 | SEQUENCE (SIZE (1..2)) |
| OF PUCCH-ResourceId | OPTIONAL, -- Need M |

-------------------------------other unchanged parts are
omitted---------------------------------
}

Wherein, multi-CSI-PUCCH-ResourceList1 and multi-CSI-PUCCH-ResourceList2 are associated with CORESETPoolIndex 0 and 1 respectively, and they are further associated with the first and second common beam. For example, 2 PUCCH resources are configured per multi-CSI-PUCCH-ResourceList. If the multiplexed UCI bits are associated with the first common beam, then the first or second PUCCH resource from multi-CSI-PUCCH-ResourceList1 is determined according to the UCI bits for the UCI multiplexing. If the multiplexed UCI bits are associated with the second common beam, then the first or second PUCCH resource from multi-CSI-PUCCH-ResourceList2 is determined according to the UCI bits for the UCI multiplexing. In addition, in some other embodiments of the present application, multi-CSI-PUCCH-ResourceList1 may still use the same expression in legacy specification, i.e., multi-CSI-PUCCH-ResourceList. Persons skilled in the art should well know that in this case the “multi-CSI-PUCCH-ResourceList” in the RRC configuration is only one specific configuration instance and should not be interpreted into only one multi-CSI-PUCCH-ResourceList being configured.

After UCI multiplexing on PUCCH resource is performed per TRP, e.g., in Cases 1-1, 1-2 and 1-3, at least one PUCCH resource will be determined by the UE based on the one or more PUCCH resources indicated by the network side, which are expected to be transmitted on a slot. In some other scenarios, there may be no multiplexing is need. The at least one PUCCH resource may be the one or more PUCCH resources indicated by the network side. As state above, in some embodiments of the present application, at most two non-overlapping PUCCH resources per TRP will be determined which means at most 2 non-overlapping PUCCH resources associated with one common beam will be determined, wherein, at most one long PUCCH resource can be determined. That is, after the separate UCI multiplexing, there are at most 4 non-overlapping PUCCH resources determined for the two beams, and at most two long PUCCH resources associated with different common beams, wherein PUCCH resources associated with different common beams can be overlapped on the slot.

In the case that the number of the PUCCH resource(s) after the separate UCI multiplexing is not larger than Nₘₐₓ, which is related to UE's capability, then all the PUCCH resource(s) will be sent in the case of multi-panel simultaneous uplink transmission. That is, the number of the PUCCH resource(s) to be transmitted on the slot is the same as that of the PUCCH resource(s) after the separate UCI multiplexing. In the case that the number of the PUCCH resource(s) after the separate UCI multiplexing is larger than Nₘₐₓ, which is related to UE's capability, then Nₘₐₓ PUCCH resources will be selected (or determined) from the at most 4 PUCCH resources. In some embodiments of the present application, the Nₘₐₓ PUCCH resources are selected according to the highest UCI priority of each of the PUCCH resources (e.g., at most 4 PUCCH resources) after the separate UCI multiplexing.

An exemplary priority order of different types of UCI is: priority of HARQ-ACK information (HARQ-ACK with corresponding DCI and other HARQ-ACK information) is larger than that of SR, and priority of SR is larger than that of CSI report. If a PUCCH resource carrying multiple types of UCI, then the priority of the PUCCH resource is determined by the highest priority of the multiple types of UCI on the PUCCH resource. If two or more PUCCH resources have the same highest priority of the multiple types of UCIs, then the priority of the two or more PUCCH resources will be further determined in various manners. For example, if two or more PUCCH resources have the same highest priority of the multiple types of UCIs, then the priority of the two or more PUCCH resources will be further determined by the second priority of the multiple types of UCIs on each PUCCH resource and so on. In another example, if two or more PUCCH resources have the same highest priority of the multiple types of UCIs, then the priority of the two or more PUCCH resources will be further determined by its associated CORSETPoolIndex value or its associated beam. For example, the PUCCH resource associated with CORESETPoolIndex 0 (the first TRP) or the first common beam will have a higher priority than CORESETPoolIndex 1 (the second TRP) or the second common beam.

### Scenario 2: Joint UCI Multiplexing Mode-Joint UCI Multiplexing for Both TRPs

In Scenario 2, legacy UCI multiplexing procedures can be reused for joint UCI multiplexing in the case of multi-panel simultaneous UL transmission. For example, if a UE is configured with multiple PUCCH resources on a slot to transmit CSI reports, then a first PUCCH resource is determined according to a CSI report with the highest priority, and a second PUCCH resource which is not overlapping with the first PUCCH resource is determined according to the priority and PUCCH format as follows according to TS 38.214.
“if the UE is not provided multi-CSI-PUCCH-ResourceList or if PUCCH resources for transmissions of CSI reports do not overlap on the slot, the UE determines a first resource corresponding to a CSI report with the highest priority [6, TS 38.214]
   if the first resource includes PUCCH format 2, and if there are remaining resources on the slot that do not overlap with the first resource, the UE determines a CSI report with the highest priority, among the CSI reports with corresponding resources from the remaining resources, and a corresponding second resource as an additional resource for CSI reporting
   if the first resource includes PUCCH format 3 or PUCCH format 4, and if there are remaining resources on the slot that include PUCCH format 2 and do not overlap with the first resource, the UE determines a CSI report with the highest priority, among the CSI reports with corresponding resources from the remaining resources, and a corresponding second resource as an additional resource for CSI reporting.”

Embodiments of the present application enhance the selection of the second PUCCH resource carrying CSI report when UE supports multi-panel simultaneous UL transmission. Different from the legacy technology, when the priority of the second PUCCH resource is higher than the PUCCH resources non-overlapping with the first PUCCH resource, the second PUCCH resource can be selected from the overlapping PUCCH resources of the first PUCCH resource while associated with a different common beam of the first PUCCH resource in the common beam frame.

For example, according to some embodiments of the present application, in the case that a UE is configured with multiple PUCCH resources on a slot to transmit CSI reports, then at most 2 PUCCH resources can be determined for CSI reports as follows, wherein zero or one (at most one) of the at most 2 PUCCH resources are long PUCCH resource.

First, in the case that the UE is not provided multi-CSI-PUCCH-ResourceList or PUCCH resources for transmissions of CSI reports associated with a beam do not overlap on a slot, a first PUCCH resource corresponding to a CSI report with the highest priority will be determined.

In the case that there is a first set of PUCCH resource on the slot not overlapping with the first PUCCH resource, a third PUCCH resource corresponding to a CSI report with the highest priority will be determined from the first set of PUCCH resources, wherein at most one PUCCH resource of the first PUCCH resource and the third PUCCH resource is a long PUCCH resource. For example, if the first PUCCH resource is a long PUCCH resource with PUCCH format 3 or 4, the third PUCCH resource will be a short PUCCH resource with PUCCH format 2; and if the first PUCCH resource is a short PUCCH resource with PUCCH format 2, the third PUCCH resource will be a long PUCCH resource with PUCCH format 3 or 4.

In the case that there is a second set of PUCCH resource on the slot overlapping with the first PUCCH resource while associated with another beam different from the first PUCCH resource, a fourth PUCCH resource corresponding to a CSI report with the highest priority will be determined from the second set of PUCCH resource on the slot. Similarly, at most one of the first PUCCH resource and the fourth PUCCH resource is a long PUCCH resource. For example, if the first PUCCH resource is a long PUCCH resource with PUCCH format 3 or 4, the fourth PUCCH resource will be a short PUCCH resource with PUCCH format 2; and if the first PUCCH resource is a short PUCCH resource with PUCCH format 2, the fourth PUCCH resource will be a long PUCCH resource with PUCCH format 3 or 4.

Then, a PUCCH resource with a higher priority from the third PUCCH resource and the fourth PUCCH resource will be determined as the second PUCCH resource to be transmitted on the slot.

According to some embodiments of the present application, in the case that a UE is configured with multiple PUCCH resources on a slot to transmit CSI reports, then at most 2 PUCCH resources can be determined for CSI reports as follows, wherein zero, or one or both (at most two) of the at most 2 PUCCH resources are long PUCCH resource.

First, a first PUCCH resource corresponding to a CSI report with the highest priority will be determined in the case that the UE is not provided multi-CSI-PUCCH-ResourceList or PUCCH resources for transmissions of CSI reports associated with a beam do not overlap on the slot.

In the case that there is a first set of PUCCH resource on the slot not overlapping with the first PUCCH resource, a third PUCCH resource corresponding to a CSI report with the highest priority will be determined from the first set of PUCCH resources, wherein at most one of the first PUCCH resource and the third PUCCH resource is a long PUCCH resource. For example, if the first PUCCH resource is a long PUCCH resource with PUCCH format 3 or 4, the third PUCCH resource will be a short PUCCH resource with PUCCH format 2; and if the first PUCCH resource is a short PUCCH resource with PUCCH format 2, the third PUCCH resource will be a long PUCCH resource with PUCCH format 3 or 4.

In the case that there is a second set of PUCCH resource on the slot overlapping with the first PUCCH resource while associated with another beam different from the first PUCCH resource, a fourth PUCCH resource corresponding to a CSI report with the highest priority will be determined from the second set of PUCCH resource on the slot. Both the first PUCCH resource and the fourth PUCCH resource can be long PUCCH resource, e.g., with PUCCH format 3 or 4.

Then, a PUCCH resource with a higher priority from the third PUCCH resource and the fourth PUCCH resource will be determined as the second PUCCH resource to be transmitted on the slot.

When joint UCI multiplexing mode is applied for CSI reports, at most two PUCCH resources can be determined for CSI reports and at most two of the at most 2 PUCCH resources are long PUCCH resource. It is identical with the case that at most 2 non-overlapped PUCCH resources for CSI reports are determined per TRP after separate UCI multiplexing, and at most 2 (Nₘₐₓ=2) PUCCH resources with the higher priority of all PUCCH resources determined for 2 TRPs are finally determined for CSI reports.

If ackNackFeedbackMode is configured as “separate” in M-DCI based M-TRP where two different CORESETPoolIndex values are configured, the HARQ-ACK corresponding to different CORESETPoolIndex values will be transmitted by different PUCCH resources. Therefore, in some embodiments of the present application, when applying the joint UCI multiplexing, the scheduling limitation of PUCCHs carrying HARQ-ACK information with corresponding DCI will be as the same as legacy specification, wherein PUCCHs carrying HARQ-ACK information with corresponding DCI associated with different CORESETPoolIndex values (different TRPs) are not expected to be overlapped if ackNackFeedbackMode is set to “separate,” even if the UE supports multi-panel simultaneous UL transmission. In some other embodiments of the present application, UE is not expected to be configured or fixed as joint UCI multiplexing if ackNackFeedbackMode is set “separate” and two CORESETPoolIndex values are configured, which means that UE is expected to configured or fixed as separate UCI multiplexing. Accordingly, there is no scheduling limitation of PUCCHs carrying HARQ-ACK information with corresponding DCI as legacy specification when UE supports multi-panel simultaneous UL transmission.

Persons skilled in the art should well know that although some embodiments of the present application are illustrated in view of the common beam frame, the illustrated schemes can also be applied to scenarios of non-common beam frame where two specific beams are associated with two TRPs respectively, and should not limit the solution of the present application to the specific embodiments.

Besides the methods, embodiments of the present application also propose an apparatus of uplink transmission.

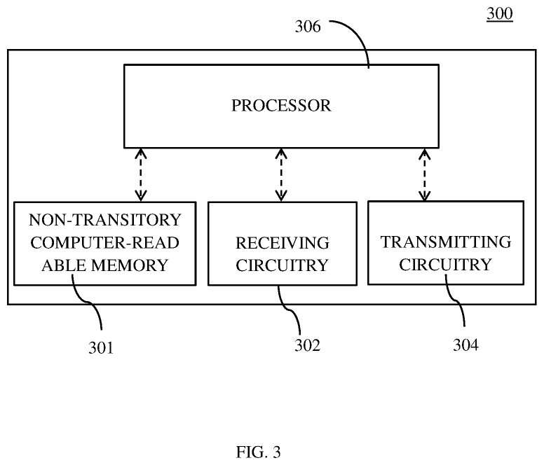

For example, FIG. 3 illustrates a block diagram of an apparatus of uplink transmission 300 according to some embodiments of the present application.

As shown in FIG. 3, the apparatus 300 may include at least one non-transitory computer-readable medium 301, at least one receiving circuitry 302, at least one transmitting circuitry 304, and at least one processor 306 coupled to the non-transitory computer-readable medium 301, the receiving circuitry 302 and the transmitting circuitry 304. The at least one processor 306 may be a CPU, a DSP, a microprocessor etc. The apparatus 300 may be a RAN node, e.g., a gNB or a remote apparatus, e.g., UE configured to perform a method illustrated in the above or the like.

Although in this figure, elements such as the at least one processor 306, transmitting circuitry 304, and receiving circuitry 302 are described in the singular, the plural is contemplated unless a limitation to the singular is explicitly stated. In some embodiments of the present application, the receiving circuitry 302 and the transmitting circuitry 304 can be combined into a single device, such as a transceiver. In certain embodiments of the present application, the apparatus 300 may further include an input device, a memory, and/or other components.

In some embodiments of the present application, the non-transitory computer-readable medium 301 may have stored thereon computer-executable instructions to cause a processor to implement the method with respect to the network apparatus as described above. For example, the computer-executable instructions, when executed, cause the processor 306 interacting with receiving circuitry 302 and transmitting circuitry 304, so as to perform the steps with respect to the RAN node or network apparatus, e.g., a gNB as depicted above.

In some embodiments of the present application, the non-transitory computer-readable medium 301 may have stored thereon computer-executable instructions to cause a processor to implement the method with respect to the UE as described above. For example, the computer-executable instructions, when executed, cause the processor 306 interacting with receiving circuitry 302 and transmitting circuitry 304, so as to perform the steps with respect to the UE as illustrated above.

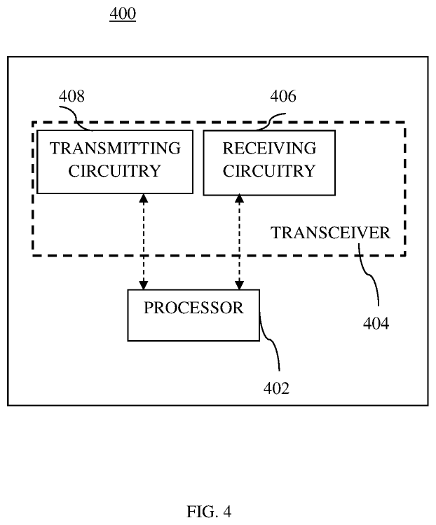

FIG. 4 is a block diagram of an apparatus of uplink transmission according to some other embodiments of the present application.

Referring to FIG. 4, the apparatus 400, for example a gNB or a UE may include at least one processor 402 and at least one transceiver 404 coupled to the at least one processor 402. The transceiver 404 may include at least one separate receiving circuitry 406 and transmitting circuitry 404, or at least one integrated receiving circuitry 406 and transmitting circuitry 404. The at least one processor 402 may be a CPU, a DSP, a microprocessor etc.

According to some embodiments of the present application, when the apparatus 400 is a remote apparatus, e.g., a UE, the processor is configured to: receive information indicating one or more PUCCH resources which are expected to be transmitted on a slot; and determine a number of PUCCH resources to be transmitted on the slot from at least one PUCCH resource determined according to the one or more PUCCH resources and an UCI multiplexing mode, wherein the number of PUCCH resources is equal to or smaller than a configured or predefined maximum number and there is no overlapping PUCCH resources associated with a same beam in the number of PUCCH resources.

According to some other embodiments of the present application, when the apparatus 400 is a RAN node, e.g., a gNB, the processor may be configured to: transmit information indicating one or more PUCCH resources which are expected to be transmitted on a slot; and receive a number of PUCCH resources, wherein the number of PUCCH resource is determined from at least one PUCCH resource determined based on the one or more PUCCH resources and an UCI mode in a UE side and is equal to or smaller than a configured or predefined maximum number, and there is no overlapping PUCCH resources associated with a same beam in the number of PUCCH resources.

The method according to embodiments of the present application can also be implemented on a programmed processor. However, the controllers, flowcharts, and modules may also be implemented on a general purpose or special purpose computer, a programmed microprocessor or microcontroller and peripheral integrated circuit elements, an integrated circuit, a hardware electronic or logic circuit such as a discrete element circuit, a programmable logic device, or the like. In general, any device capable of implementing the flowcharts shown in the figures may be used to implement the processor functions of this application. For example, an embodiment of the present application provides an apparatus, including a processor and a memory. Computer programmable instructions for implementing a method are stored in the memory, and the processor is configured to perform the computer programmable instructions to implement the method. The method may be a method as stated above or other method according to an embodiment of the present application.

An alternative embodiment preferably implements the methods according to embodiments of the present application in a non-transitory, computer-readable storage medium storing computer programmable instructions. The instructions are preferably executed by computer-executable components preferably integrated with a network security system. The non-transitory, computer-readable storage medium may be stored on any suitable computer readable media such as RAMs, ROMs, flash memory, EEPROMs, optical storage devices (CD or DVD), hard drives, floppy drives, or any suitable device. The computer-executable component is preferably a processor but the instructions may alternatively or additionally be executed by any suitable dedicated hardware device. For example, an embodiment of the present application provides a non-transitory, computer-readable storage medium having computer programmable instructions stored therein. The computer programmable instructions are configured to implement a method as stated above or other method according to an embodiment of the present application.

In addition, in this disclosure, the terms “includes,” “including,” or any other variation thereof, are intended to cover a non-exclusive inclusion, such that a process, method, article, or apparatus that includes a list of elements does not include only those elements but may include other elements not expressly listed or inherent to such process, method, article, or apparatus. An element proceeded by “a,” “an,” or the like does not, without more constraints, preclude the existence of additional identical elements in the process, method, article, or apparatus that includes the element. Also, the term “another” is defined as at least a second or more. The terms “having,” and the like, as used herein, are defined as “including.”

1. A user equipment (UE), comprising:
at least one memory; and
at least one processor coupled with the at least one memory and configured to cause the UE to:
receive information indicating one or more physical uplink control channel (PUCCH) resources which are expected to be transmitted on a slot; and
determine a number of PUCCH resources to be transmitted on the slot from at least one PUCCH resource determined according to the one or more PUCCH resources and an uplink control information (UCI) multiplexing mode, wherein the number of PUCCH resources is equal to or smaller than a configured or predefined maximum number and there is no overlapping PUCCH resources associated with a same beam in the number of PUCCH resources.

2. The UE of claim 1, wherein, in the case that if the UCI multiplexing mode is separate UCI multiplexing, one resourceSetToAddModList is configured for PUCCH resource configuration, and one PUCCH resource associated with a beam of the one or more PUCCH resources carrying hybrid automatic repeat request-acknowledge (HARQ-ACK) information with corresponding downlink control information (DCI) is overlapping with at least one other PUCCH resource carrying other UCI information associated with the beam of the one or more PUCCH resources,
the at least one PUCCH resource comprises a PUCCH resource for multiplexing the HARQ-ACK information and the other UCI information, wherein, the PUCCH resource is determined from a PUCCH resource set determined from the resourceSetToAddModList according to a total bit number of the HARQ-ACK information and the other UCI information, and
if the PUCCH resource set is a first PUCCH resource set determined from the resourceSetToAddModList and a total number of PUCCH resources associated with the beam in the first PUCCH resource set is larger than 8, the PUCCH resource for multiplexing the HARQ-ACK information and the other UCI information is determined from all PUCCH resources associated with the beam in the first PUCCH resource set according to a PUCCH resource indicator (PRI) field in a last DCI corresponding to the HARQ-ACK information with corresponding DCI and a control resource set (CORESET) of the last DCI corresponding to the HARQ-ACK information with corresponding DCI;
otherwise, the PUCCH resource for multiplexing the HARQ-ACK information and the other UCI information is determined from all PUCCH resources associated with the beam in the PUCCH resource set according to a PRI field in a last DCI corresponding to the HARQ-ACK information with corresponding DCI.

3. The UE of claim 1, wherein, if the UCI multiplexing mode is separate UCI multiplexing, one resourceSetToAddModList is configured for PUCCH resource configuration, and a PUCCH resource of the at least one PUCCH resource carries hybrid automatic repeat request-acknowledge (HARQ-ACK) information with corresponding downlink control information (DCI) associated with a beam,
the PUCCH resource is determined from a PUCCH resource set determined from the resourceSetToAddModList according to a total bit number of the HARQ-ACK information, wherein,
if the PUCCH resource set is a first PUCCH resource set determined from the resourceSetToAddModList and a total number of PUCCH resources associated with the beam in the first PUCCH resource set is larger than 8, the PUCCH resource is determined from all PUCCH resources associated with the beam in the first PUCCH resource set according to a PUCCH resource indicator (PRI) field in a last DCI corresponding to the HARQ-ACK information with corresponding DCI and a control resource set (CORESET) of the last DCI corresponding to the HARQ-ACK information with corresponding DCI;
otherwise, the PUCCH resource is determined from all PUCCH resources associated with the beam in the PUCCH resource set according to a PRI field in a last DCI corresponding to the HARQ-ACK information with corresponding DCI.

4. The UE of claim 1, wherein, if the UCI multiplexing mode is separate UCI multiplexing, two resourceSetToAddModLists are configured for PUCCH resource configuration, and one PUCCH resource associated with a beam of the one or more PUCCH resources carrying hybrid automatic repeat request-acknowledge (HARQ-ACK) information with corresponding downlink control information (DCI) is overlapping with at least one other PUCCH resource carrying other UCI information associated with the beam of the one or more PUCCH resources,
the at least one PUCCH resource comprises a PUCCH resource for multiplexing the HARQ-ACK information and the other UCI information, wherein, the PUCCH resource is determined from a PUCCH resource set associated with the beam determined from a resourceSetToAddModList associated with the beam of the two resourceSetToAddModLists according to a total bit number of the HARQ-ACK information and the other UCI information, and
if the PUCCH resource set is a first PUCCH resource set determined from the resourceSetToAddModList associated with the beam and a total number of PUCCH resources in the first PUCCH resource set is larger than 8, the PUCCH resource is determined from all PUCCH resources in the first PUCCH resource set according to a PUCCH resource indicator (PRI) field in a last DCI corresponding to the HARQ-ACK information with corresponding DCI and a control resource set (CORESET) of the last DCI corresponding to the HARQ-ACK information with corresponding DCI;
otherwise, the PUCCH resource is determined from all PUCCH resources in the PUCCH resource set associated with the beam according to a PRI field in a last DCI corresponding to the HARQ-ACK information with corresponding DCI.

5. The UE of claim 1, wherein, if the UCI multiplexing mode is separate UCI multiplexing, two resourceSetToAddModLists are configured for PUCCH resource configuration, and a PUCCH resource of the at least one PUCCH resource carries hybrid automatic repeat request-acknowledge (HARQ-ACK) information with corresponding downlink control information (DCI) associated with a beam,
the PUCCH resource is determined from a PUCCH resource set associated with the beam determined from a resourceSetToAddModList associated with the beam of the two resourceSetToAddModList according to a total bit number of the number of the HARQ-ACK information, and
if the PUCCH resource set is a first PUCCH resource set determined from the resourceSetToAddModList associated with the beam and a total number of PUCCH resources in the first PUCCH resource set is larger than 8, the PUCCH resource is determined from all PUCCH resources in the first PUCCH resource set according to a PUCCH resource indicator (PRI) field in a last DCI corresponding to the HARQ-ACK information with corresponding DCI and a control resource set (CORESET) of the last DCI corresponding to the HARQ-ACK information with corresponding DCI;
otherwise, the PUCCH resource is determined from all PUCCH resources in the PUCCH resource set associated with the beam according to a PRI field in a last DCI corresponding to the HARQ-ACK information with corresponding DCI.

6. The UE of claim 1, wherein, if the UCI multiplexing mode is separate UCI multiplexing, one SPS-PUCCH-AN-List is configured, and a PUCCH resource of the at least one PUCCH resource carries UCI information only including hybrid automatic repeat request-acknowledge (HARQ-ACK) information bits in response to a plurality of semi persistent scheduling (SPS) physical downlink shared channel (PDSCH) receptions associated with a beam or only including HARQ-ACK information bits in response to one or more SPS PDSCH receptions associated with a beam and schedule request (SR) associated with the beam,
the PUCCH resource is determined from all PUCCH resources associated with the beam of the SPS-PUCCH-AN-List according to a total number of bits of the UCI information.

7. The UE of claim 1, wherein, if the UCI multiplexing mode is separate UCI multiplexing, two SPS-PUCCH-AN-Lists are configured, and a PUCCH resource of the at least one PUCCH resource carries UCI information only including hybrid automatic repeat request-acknowledge (HARQ-ACK) information bits in response to a plurality of semi persistent scheduling (SPS) physical downlink shared channel (PDSCH) receptions associated with a beam or only including HARQ-ACK information bits in response to one or more SPS PDSCH receptions associated with a beam and schedule request (SR) associated with the beam,
the PUCCH resource is determined from all PUCCH resources of a SPS-PUCCH-AN-List associated with the beam of the two SPS-PUCCH-AN-Lists according to a total number of bits of the UCI information.

8. The UE of claim 1, wherein, if the UCI multiplexing mode is separate UCI multiplexing, one multi-CSI-PUCCH-ResourceList is configured, and a) a plurality of PUCCH resources associated with a beam of the one or more PUCCH resources carrying a plurality of channel state control (CSI) reports are overlapping on the slot where UCI information includes the plurality of CSI reports or b) at least one PUCCH resource associated with a beam of the one or more PUCCH resources carrying at least one CSI report and at least one other PUCCH resource associated with the beam carrying at least one of hybrid automatic repeat request-acknowledge (HARQ-ACK) information bits in response to at least one semi persistent scheduling (SPS) physical downlink shared channel (PDSCH) reception or SR information bits are overlapping on the slot where the UCI information includes the at least one CSI report and the at least one of HARQ-ACK information or SR information,
the at least one PUCCH resource comprises a PUCCH resource for multiplexing the UCI information, wherein, the PUCCH resource is determined from all PUCCH resources associated with the beam of the multi-CSI-PUCCH-ResourceList according to a total bit number of the UCI information.

9. The UE of claim 1, wherein, if the UCI multiplexing mode is separate UCI multiplexing, two multi-CSI-PUCCH-ResourceLists are configured, and a) a plurality of PUCCH resources associated with a beam of the one or more PUCCH resources carrying a plurality of channel state control (CSI) reports are overlapping on the slot where UCI information includes the plurality of CSI reports or b) at least one PUCCH resource associated with a beam of the one or more PUCCH resources carrying at least one CSI report and at least one other PUCCH resource associated with the beam carrying at least one of hybrid automatic repeat request-acknowledge (HARQ-ACK) information bits in response to at least one semi persistent scheduling (SPS) physical downlink shared channel (PDSCH) reception or SR information bits are overlapping on the slot where the UCI information includes the at least one CSI report and the at least one of HARQ-ACK information or SR information,
the at least one PUCCH resource comprises a PUCCH resource for multiplexing the UCI information, wherein, the PUCCH resource is determined from all PUCCH resources of a multi-CSI-PUCCH-ResourceList associated with the beam of the two multi-CSI-PUCCH-ResourceLists according to a total bit number of the UCI information.

10. The UE of claim 1, wherein, if the UCI multiplexing mode is separate UCI multiplexing, the at least one PUCCH resource is at most 4 PUCCH resources associated with two beams determined after the separate UCI multiplexing, and each beam is associated with at most 2 PUCCH resources of the at most 4 PUCCH resources,
the number of PUCCH resources to be transmitted is determined from the at most 4 PUCCH resources is according to a highest UCI priority of each of the at most 4 PUCCH resources.

11. The UE of claim 1, wherein if the UCI multiplexing mode is joint UCI multiplexing, there are a plurality of PUCCH resources on a slot to transmit channel state information (CSI) reports, and the number is equal to or smaller than 2, determining a number of PUCCH resources to be transmitted from the at least one PUCCH resource comprises:
determining a first PUCCH resource corresponding to a CSI report with a highest priority if the UE is not provided multi-CSI-PUCCH-ResourceList or PUCCH resources for transmissions of CSI reports associated with a beam do not overlap on the slot,
if there is a first set of PUCCH resources on the slot not overlapping with the first PUCCH resource, determining a second PUCCH resource corresponding to a CSI report with a highest priority from the first set of PUCCH resources;
if there is a second set of PUCCH resources on the slot overlapping with the first PUCCH resource while associated with another beam different from the first PUCCH resource, determining a third PUCCH resource corresponding to a CSI report with a highest priority from the second set of PUCCH resource on the slot; and
determining a PUCCH resource with a higher priority from the second PUCCH resource and the third PUCCH resource as a PUCCH to be transmitted, wherein at most one PUCCH resource of the first PUCCH resource and the second PUCCH resource includes PUCCH format 3 or 4.

12. The UE of claim 1, wherein, if ackNackFeedbackMode is configured as separate and two CORESETPoolIndex values are configured, the UCI multiplexing mode is separate UCI multiplexing.

13. The UE of claim 1, wherein, if ackNackFeedbackMode is configured as separate and two CORESETPoolIndex values are configured, a PUCCH resource carrying hybrid automatic repeat request-acknowledge (HARQ-ACK) with corresponding downlink control information (DCI) associated with different CORESETPoolIndex values are not expected to be overlapped.

14. A radio access network (RAN) node, comprising:
at least one memory; and
at least one processor coupled with the at least one memory and configured to cause the RAN node to:
transmit information indicating one or more PUCCH resources which are expected to be transmitted on a slot; and
receive a number of physical uplink control channel (PUCCH) resources, wherein the number of PUCCH resource is determined from at least one PUCCH resource determined based on the one or more PUCCH resources and an uplink control information multiplexing (UCI) mode in a user equipment (UE) side and is equal to or smaller than a configured or predefined maximum number, and there is no overlapping PUCCH resources associated with a same beam in the number of PUCCH resources.

15. A method performed by a user equipment (UE), the method comprising:
receiving information indicating one or more physical uplink control channel (PUCCH) resources which are expected to be transmitted on a slot; and
determining a number of PUCCH resources to be transmitted on the slot from at least one PUCCH resource determined according to the one or more PUCCH resources and an uplink control information (UCI) multiplexing mode, wherein the number of PUCCH resources is equal to or smaller than a configured or predefined maximum number and there is no overlapping PUCCH resources associated with a same beam in the number of PUCCH resources.

16. A processor for wireless communication, comprising:
at least one controller coupled with at least one memory and configured to cause the processor to:
receive information indicating one or more physical uplink control channel (PUCCH) resources which are expected to be transmitted on a slot; and
determine a number of PUCCH resources to be transmitted on the slot from at least one PUCCH resource determined according to the one or more PUCCH resources and an uplink control information (UCI) multiplexing mode, wherein the number of PUCCH resources is equal to or smaller than a configured or predefined maximum number and there is no overlapping PUCCH resources associated with a same beam in the number of PUCCH resources.

17. The processor of claim 16, wherein, if the UCI multiplexing mode is separate UCI multiplexing, one resourceSetToAddModList is configured for PUCCH resource configuration, and one PUCCH resource associated with a beam of the one or more PUCCH resources carrying hybrid automatic repeat request-acknowledge (HARQ-ACK) information with corresponding downlink control information (DCI) is overlapping with at least one other PUCCH resource carrying other UCI information associated with the beam of the one or more PUCCH resources,
the at least one PUCCH resource comprises a PUCCH resource for multiplexing the HARQ-ACK information and the other UCI information, wherein, the PUCCH resource is determined from a PUCCH resource set determined from the resourceSetToAddModList according to a total bit number of the HARQ-ACK information and the other UCI information, and
if the PUCCH resource set is a first PUCCH resource set determined from the resourceSetToAddModList and a total number of PUCCH resources associated with the beam in the first PUCCH resource set is larger than 8, the PUCCH resource for multiplexing the HARQ-ACK information and the other UCI information is determined from all PUCCH resources associated with the beam in the first PUCCH resource set according to a PUCCH resource indicator (PRI) field in a last DCI corresponding to the HARQ-ACK information with corresponding DCI and a control resource set (CORESET) of the last DCI corresponding to the HARQ-ACK information with corresponding DCI;
otherwise, the PUCCH resource for multiplexing the HARQ-ACK information and the other UCI information is determined from all PUCCH resources associated with the beam in the PUCCH resource set according to a PRI field in a last DCI corresponding to the HARQ-ACK information with corresponding DCI.

18. The processor of claim 16, wherein, if the UCI multiplexing mode is separate UCI multiplexing, one resourceSetToAddModList is configured for PUCCH resource configuration, and a PUCCH resource of the at least one PUCCH resource carries hybrid automatic repeat request-acknowledge (HARQ-ACK) information with corresponding downlink control information (DCI) associated with a beam,
the PUCCH resource is determined from a PUCCH resource set determined from the resourceSetToAddModList according to a total bit number of the HARQ-ACK information, wherein,
if the PUCCH resource set is a first PUCCH resource set determined from the resourceSetToAddModList and a total number of PUCCH resources associated with the beam in the first PUCCH resource set is larger than 8, the PUCCH resource is determined from all PUCCH resources associated with the beam in the first PUCCH resource set according to a PUCCH resource indicator (PRI) field in a last DCI corresponding to the HARQ-ACK information with corresponding DCI and a control resource set (CORESET) of the last DCI corresponding to the HARQ-ACK information with corresponding DCI;
otherwise, the PUCCH resource is determined from all PUCCH resources associated with the beam in the PUCCH resource set according to a PRI field in a last DCI corresponding to the HARQ-ACK information with corresponding DCI.

19. The processor of claim 16, wherein, if the UCI multiplexing mode is separate UCI multiplexing, two resourceSetToAddModLists are configured for PUCCH resource configuration, and one PUCCH resource associated with a beam of the one or more PUCCH resources carrying hybrid automatic repeat request-acknowledge (HARQ-ACK) information with corresponding downlink control information (DCI) is overlapping with at least one other PUCCH resource carrying other UCI information associated with the beam of the one or more PUCCH resources,
the at least one PUCCH resource comprises a PUCCH resource for multiplexing the HARQ-ACK information and the other UCI information, wherein, the PUCCH resource is determined from a PUCCH resource set associated with the beam determined from a resourceSetToAddModList associated with the beam of the two resourceSetToAddModLists according to a total bit number of the HARQ-ACK information and the other UCI information, and
if the PUCCH resource set is a first PUCCH resource set determined from the resourceSetToAddModList associated with the beam and a total number of PUCCH resources in the first PUCCH resource set is larger than 8, the PUCCH resource is determined from all PUCCH resources in the first PUCCH resource set according to a PUCCH resource indicator (PRI) field in a last DCI corresponding to the HARQ-ACK information with corresponding DCI and a control resource set (CORESET) of the last DCI corresponding to the HARQ-ACK information with corresponding DCI;
otherwise, the PUCCH resource is determined from all PUCCH resources in the PUCCH resource set associated with the beam according to a PRI field in a last DCI corresponding to the HARQ-ACK information with corresponding DCI.

20. The processor of claim 16, wherein, if the UCI multiplexing mode is separate UCI multiplexing, two resourceSetToAddModLists are configured for PUCCH resource configuration, and a PUCCH resource of the at least one PUCCH resource carries hybrid automatic repeat request-acknowledge (HARQ-ACK) information with corresponding downlink control information (DCI) associated with a beam,
the PUCCH resource is determined from a PUCCH resource set associated with the beam determined from a resourceSetToAddModList associated with the beam of the two resourceSetToAddModList according to a total bit number of the number of the HARQ-ACK information, and
if the PUCCH resource set is a first PUCCH resource set determined from the resourceSetToAddModList associated with the beam and a total number of PUCCH resources in the first PUCCH resource set is larger than 8, the PUCCH resource is determined from all PUCCH resources in the first PUCCH resource set according to a PUCCH resource indicator (PRI) field in a last DCI corresponding to the HARQ-ACK information with corresponding DCI and a control resource set (CORESET) of the last DCI corresponding to the HARQ-ACK information with corresponding DCI;
otherwise, the PUCCH resource is determined from all PUCCH resources in the PUCCH resource set associated with the beam according to a PRI field in a last DCI corresponding to the HARQ-ACK information with corresponding DCI.
